(19) United States
(12) Patent Application Publication
(10) Pub. No.: US 2012/0325333 A1
(43) Pub. Date: Dec. 27, 2012

(54) METHOD AND DEVICE FOR CLEANING A WATER LINE

(75) Inventor: Athanasios Athanasiou, Giengen (DE)

(73) Assignee: BSH BOSCH UND SIEMENS HAUSGERÄTE GMBH, Munich (DE)

(21) Appl. No.: 13/583,230

(22) PCT Filed: Feb. 24, 2011
(86) PCT No.: PCT/EP2011/052717

§ 371 Date: Sep. 7, 2012

(30) Foreign Application Priority Data
Mar. 19, 2010 (DE) 10 2010 003 090.2

(51) Int. Cl. B08B 9/032

(52) U.S. Cl. 137/238; 134/22.11; 134/166 C

(57) ABSTRACT

Apparatus for cleaning an internal water line of a household appliance, in particular of a refrigerating device, includes a chamber which contains a cleaning substance or can be filled with the cleaning substance. An inlet connection is in communication with the chamber and configured identical to an inlet connection of the internal water line, and an outlet connection is in communication with the chamber and configured to complement the inlet connection of the apparatus.

The present invention relates to a method and an apparatus for cleaning an internal water line of a household appliance, in particular of a refrigerating device.

Refrigerating devices with an integrated ice-maker and/or cold water dispenser are enjoying increasing popularity. Refrigerating devices of this type usually have an internal water line which is connected to a mains water supply network in order to be able to immediately refill an integrated storage container of the cold water dispenser or a molded tray of the ice maker after each withdrawal, so that sufficient cold water or ice is available at any time. The water outlet points of the water dispenser and/or the ice maker are usually not provided with a hermetically closing stop valve, thereby rendering it possible for germs to spread from these water outlet points into the storage container and/or the internal water line of the device. It is therefore desirable to clean this internal water line from time to time. Such cleaning must usually be carried out by the service department of the refrigerating device manufacturer and is therefore both complicated for a user to organize and costly.

The object of the present invention is to also render the cleaning of an internal water line of a household appliance simple and cost-effective for the user.

The object is achieved on the one hand by a method for cleaning an internal water line having the steps:
inserting a chamber containing a cleaning substance between an external water line and the internal water line of the device, and
drawing off water at an outlet of the internal water line, until the cleaning substance is flushed through the internal water line.

A further object of the invention is an apparatus for implementing this method. The apparatus includes a chamber in accordance with a first simple embodiment, which contains the cleaning substance or can be filled with the same and which comprises an inlet connection which is identical to an inlet connection of the internal water line and an outlet connection which complements the inlet connection. A user can easily insert such an apparatus between the external and internal water line and allow water to flow therethrough until this has flushed the cleaning substance completely out of the chamber and through the internal water line. The chamber can then be removed again or, after the cleaning substance has been completely flushed out and does not hinder the flow of water, it can remain therein until it is refilled or replaced within the scope of a new cleaning process.

A filter is preferably arranged between the chamber and the complementary connection of the apparatus in order to retain solid particles in the cleaning substance in the chamber until they are completely dissolved or their particle size is reduced to such a degree that after passing through the filter during their passage through the internal water line they completely dissolve.

A destructible membrane can be arranged between the chamber and at least one of the connections. This is then particularly expedient if the apparatus with a filled chamber is to be marketed as disposable in order to ensure that the cleaning substance remains in the chamber until the apparatus is used.

The membrane may in particular be destroyed by the water pressure acting during use. This allows a user to insert the apparatus with the intact membrane between an external and internal water line, so that leakage of the cleaning substance is ruled out during assembly. It is then sufficient to place the external line under pressure, in order to destroy the membrane so that the cleaning substance can be flushed out by the water.

In particular, if the apparatus is provided for multiple use, provision can expediently be made for a third connection to fill the cleaning substance. A user can then refill the cleaning substance without having to disassemble the apparatus between the external and internal water line.

A multiway valve can advantageously also be provided in such an apparatus, which, in a first position, inserts the chamber between the inlet connection and outlet connection of the apparatus and in a second position connects the inlet connection and outlet connection by bypassing the chamber. Such a multiway valve prevents water from escaping out of the lines via the third connection if this is open in order to refill the chamber.

The subject matter of the invention is also a household appliance with an internal water line, which is arranged upstream of an apparatus of the afore-described type.

An apparatus for cleaning the internal water line may also be fixedly integrated in a household appliance. The connections of the chamber and the internal water line which complement one another may then be omitted. In order to be able to refill the cleaning substance in a user-friendly and safe manner, the afore-cited multiway valve is expediently present.

Further features and advantages of the invention result from the subsequent description of exemplary embodiments with reference to the appended figures, in which:

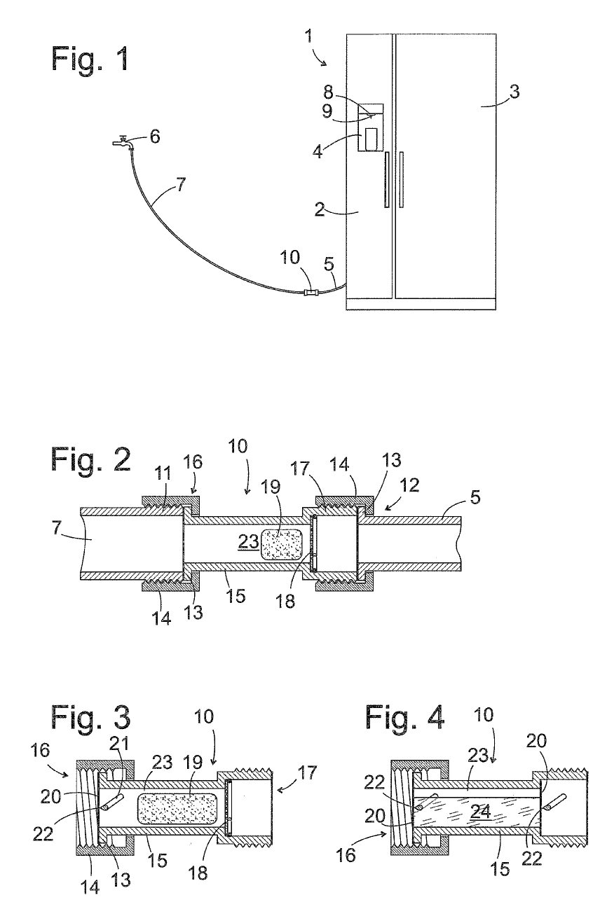

FIG. 1 shows a schematic representation of a refrigerating device, which is cleaned with the inventive method;

FIG. 2 shows a first embodiment of the inventive apparatus, mounted between an external water line and an internal water line of the refrigerating device;

FIG. 3 shows a second embodiment of the apparatus;

FIG. 4 shows a third embodiment of the apparatus;

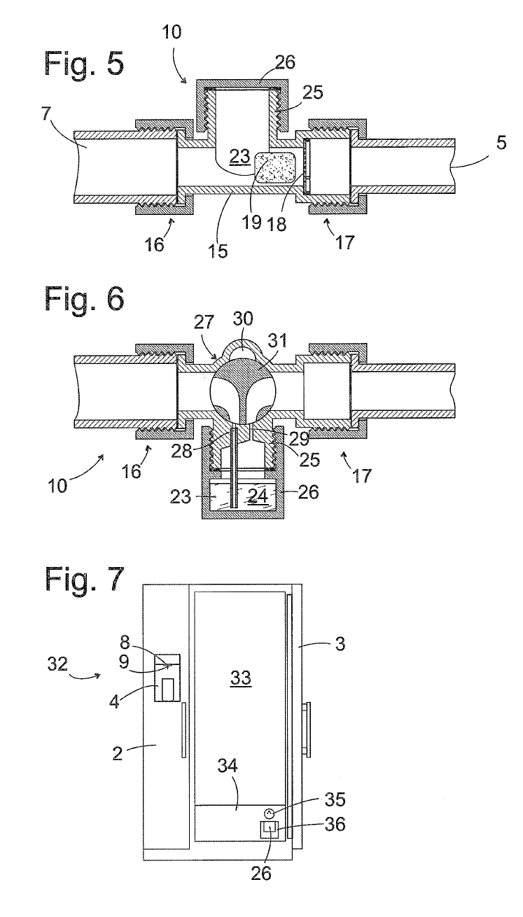

FIG. 5 shows a fourth embodiment of the apparatus;

FIG. 6 shows a fifth embodiment of the apparatus; and

FIG. 7 shows a schematic view of a refrigerating device having a fixedly installed cleaning apparatus according to the invention.

FIG. 1 shows a household appliance 1 of the type known per se, here a side-by-side combination device with two refrigeration chambers with different widths disposed adjacent to one another, here closed by a door 2, 3 in each instance. A recess 4 for a cold water dispenser is recessed into the door 2. An automatic ice maker (not shown) is accommodated in an upper region of the refrigeration chamber disposed behind the door 1 and held at below 0° C. during operation, and an ejection channel 8 for ice pieces generated by the ice maker opens into the recess 4. A cold water tank which supplies the cold water dispenser is embedded in a frost-free manner in an insulation layer of the door 2 and is connected to an outlet 9 on the ceiling of the recess 4. The ice maker and the cold water tank are supplied by an internal water line of the device 1, which is partially fixedly placed in the apparatus 1 and one part of which is formed by a tube 5, the upstream end of which is shown extracted from the refrigerating device 1 in the Figure. A cleaning apparatus 10 is inserted between the tube 5 of the apparatus and an external tube 7 connected to a water tap 6.

FIG. 2 shows the cleaning apparatus 10 and connections 11, 12 of the tubes 5, 7 connected thereto in a longitudinal section. The connection 11 of the external tube 7 has an outer thread, the connection 12 of the tube 5 on the apparatus side has an annular flange 13 and a rotatable sleeve 14 put over the annular flange 13 with an inner thread which matches the thread of the connection 11. The connections 11, 12 can therefore be directly connected to one another if the cleaning apparatus 10 is not present.

The cleaning apparatus 10 mounted between the connections 11, 12 itself includes a short tubular piece 15, which delimits a chamber 23 and, at the ends of the tubular piece 15, an inlet connection 16 similar in structure to the connection 12 and/or an outlet connection 17 similar in structure to the connection 11. A filter 18 crossing the tubular piece 15 is mounted adjacent to the outlet connection 17. The filter 18 prevents the detergent tablet 19 fixedly inserted into the tubular piece 15 by way of the inlet connection 16 from being flushed through by water flowing therethrough.

In order to clean the internal water line of the refrigerating device 1, a user closes the water tap 6, separates the connections 11, 12 from one another and therebetween mounts the cleaning apparatus 10 together with the detergent tablet 19 positioned in its chamber 23. The user can put the tablet 19 into the cleaning apparatus 10 him/herself. It is also conceivable to market the cleaning apparatus 10 equipped with the tablet 19, wherein at least the inlet connection 16 is expediently closed, for instance by a film sealing the annular flange 13, which is to be removed at the time of installation, in order to prevent the table 19 from falling out.

A further developed embodiment of the cleaning apparatus 10 is shown in FIG. 3. Here the inlet connection 16 is actually closed by a film 20 sealed on the flange 13. It is however not necessary for the user to remove the film 20 prior to installation of the cleaning apparatus 10 between the tubes 7, 5. A web 21 crossing the inside of the tubular piece 15 has a sharp point 22 facing the film 20. If the cleaning apparatus 10 is mounted and the water tap 6 is opened, the water pushes the film 20 against the point 22 so that the film 20 rips and the water can flow.

FIG. 4 shows a further embodiment of the cleaning apparatus 10, in which the chamber 23 inside the tubular piece 15 is closed on two sides by films 20. A sharp point 22 faces both films, said point causing the film 20 to rip in the event of sufficient pressure prevailing on the sides of the inlet connection 16. Since the films 20, provided they are intact, tightly close the chamber 23, a liquid cleaning agent 24 can be used here instead of the detergent tablet 19. This is quickly flushed out of the chamber 23 after the film 10 is ripped and passes through the internal water line at a high concentration. A relatively small amount of liquid passing therethrough in a short period of time is therefore sufficient to implement a cleaning process.

FIG. 5 shows an embodiment of the cleaning apparatus 10, which is provided in particular for permanent use between the tubes 5, 7. A third connection 25 is arranged at a right angle to the inlet and outlet connection 16, 17 on the tubular piece 15 and is closed by a screwed-on cover 26. It is sufficient here to unscrew the cover 26 in order to be able to insert a detergent table 19 into the inner chamber 23 of the cleaning apparatus 10.

A further development of the embodiment from FIG. 5 is shown in FIG. 6. A multiway valve 27 is arranged between the connections 16, 17, 25. A chamber 23, which can receive liquid or also solid detergent 24, is formed in the cover 26 screwed against the connection 25 from below. The multiway valve 27 is shown in a position in which it guides water through a bottleneck 28 into the chamber 23 and the water mixed with the detergent 24 flows via a second bottleneck 29 to the outlet connection 17. The bottlenecks 28, 29 delimit the water flow rate and therefore provide for an adequate dwell time of the detergent 24 in the internal water line.

After the cleaning process has been implemented, a closing element 31 of the multiway valve 27 is rotated by 180° C. so that its inner channels open onto a protrusion 30 lying opposite the chamber 23. Its free cross-section is clearly larger than that of the bottlenecks 28, 29, so that in this position water can flow essentially unhindered through the apparatus 10.

In this position of the multiway valve 27, the chamber 23 is decoupled from the water flow. The cover 26 can therefore be unscrewed and refilled without water being able to escape. Preparation of a cleaning process therefore does not require closure of the water tap 6, which is then particularly advantageous if this is concealed by the refrigerating device 1.

FIG. 7 shows a schematic view of a refrigerating device 31 having a fixedly integrated cleaning apparatus 10 of the type shown in FIG. 6. The refrigerating device 32 is a side-by-side combination device like that shown in FIG. 1. It is shown with an open door 3; for the sake of clarity the normal cooling chamber 33 arranged therebehind is shown without built-in components. The depth of the normal cooling chamber 33 is reduced in its lower region by a projection 34, behind which a compressor recess which opens to the rear of the device is found in a known manner. The cleaning apparatus 10 is also accommodated in the projection 24. A rotary button 35 for actuating the multiway valve 27 and the cover 26 screwed from below against the multiway valve in a recess 26 are also visible to a user. The user can access the cover 26 and fill it with detergent without having to move the refrigerating device 31 herefor or having to access its connection to the water tap 6.

1-9. (canceled)

10. A method for cleaning an internal water line of a household appliance, comprising:
inserting a chamber containing a cleaning substance between an external water line and the internal water line; and
drawing off water from an outlet of the internal water line until the cleaning substance is flushed through the internal water line.

11. The method of claim 10 for cleaning an internal water line of a refrigerating device.

12. Apparatus for cleaning an internal water line of a household appliance, comprising:
a chamber containing a cleaning substance;
an inlet connection adapted for communication with the chamber and configured identical to an inlet connection of the internal water line; and
an outlet connection adapted for communication with the chamber and configured to complement the inlet connection of the apparatus.

13. The apparatus of claim 12, wherein the household appliance is a refrigerating device.

14. The apparatus of claim 12, further comprising a filter arranged between the chamber and the outlet connection.

15. The apparatus of claim 12, further comprising a destructible membrane arranged between the chamber and at least one of the inlet and outlet connections of the apparatus.

16. The apparatus of claim 15, wherein the membrane is configured for destruction by applying pressure to the inlet connection of the apparatus.

17. The apparatus of claim 12, further comprising a third connection in communication with the chamber for filling the cleaning substance into the chamber.

18. The apparatus of claim 12, further comprising a multiway valve switchable between a first position in which the chamber is in communication with the inlet and outlet connections of the apparatus, and a second position in which the inlet connection is connected to the outlet connection by bypassing the chamber.

19. A household appliance, comprising:
an internal water line having an inlet connection; and
an apparatus arranged upstream of the internal water line for cleaning the internal water line, said apparatus comprising:
a chamber containing a cleaning substance,
an inlet connection adapted for communication with the chamber and configured identical to the inlet connection of the internal water line, and
an outlet connection adapted for communication with the chamber and complementing the inlet connection of the apparatus.

20. The household appliance of claim 19, constructed in the form of a refrigerating device.

21. The household appliance of claim 19, wherein the apparatus comprises a filter arranged between the chamber and the outlet connection.

22. The household appliance of claim 19, wherein the apparatus comprises a destructible membrane arranged between the chamber and at least one of the inlet and outlet connections of the apparatus.

23. The household appliance of claim 22, wherein the membrane is configured for destruction by applying pressure to the inlet connection of the apparatus.

24. The household appliance of claim 19, further comprising a third connection in communication with the chamber for filling the cleaning substance into the chamber.

25. The household appliance of claim 19, wherein the apparatus comprises a multiway valve switchable between a first position in which the chamber is in communication with the inlet and outlet connections of the apparatus, and a second position in which the inlet connection is connected to the outlet connection by bypassing the chamber.

26. A household appliance, comprising:
an internal water line;
a chamber which can be filled with a cleaning substance; and
a multiway valve switchable between a first position in which the chamber is in communication with the internal water line and an external water line, and a second position in which the internal water line and the external water line are connected by bypassing the chamber.
